(19) United States
(12) Patent Application Publication
(10) Pub. No.: US 2005/0193134 A1
(43) Pub. Date: Sep. 1, 2005

(54) Method for logging a user out of a service

(76) Inventor: Jari Syrjala, Helsinki (SE)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/512,177

(22) PCT Filed: Apr. 22, 2003
(86) PCT No.: PCT/FI03/00317

§ 371 Date: Oct. 22, 2004

(51) Int. Cl. G06F 15/16

(52) U.S. Cl. 709/230; 709/227

(57) ABSTRACT

An object of the invention is a method for logging out a user of an application-layer service, the service being implemented with the aid of a user's wireless terminal, the terminal implementing a protocol stack comprising an application layer, and which application layer comprises a set of service applications for implementing application-layer services, and an application-layer control and signalling protocol, such as SIP (Session Initiation Protocol), for logging the user on application-layer services in a network and for logging the user out of application-layer services. According to the method, when switching off the wireless terminal, the user is logged using the application-layer control and signalling protocol out of at least one application-layer service of which the user has not logged out, or a conditional request for logging out the user is sent to the network.

The invention relates to logging a user of a wireless terminal out of an application-layer service.

SIP (Session Initiation Protocol) protocol has been suggested and also decided to be used for signalling in communication networks and terminals based on 3GPP (3^{rd} Generation Partnership Project) Release 5 and All IP (Internet Protocol). In these networks, the aim is to offer terminals many kinds of services, some of which are non-real-time, such as Instant Messaging, presence and chat services, and some are real-time, such as voice, video and multimedia calls. The object is to use SIP protocol for signalling of both real-time and non-real-time services.

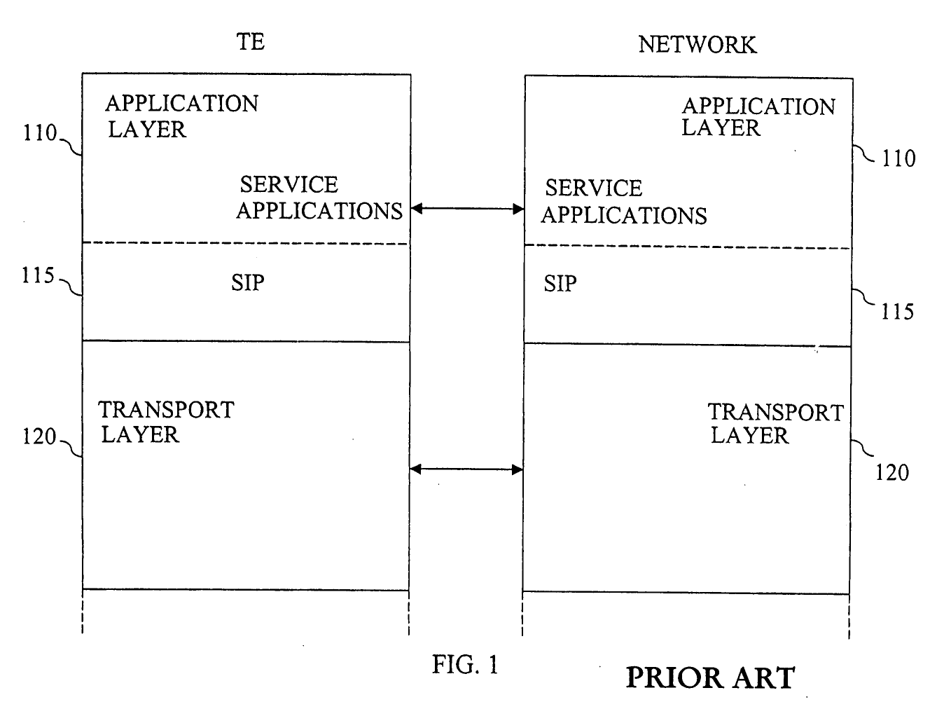

Communication between above-mentioned networks and wireless terminals is implemented with a layer-structured protocol stack implemented in both the wireless terminal and the network. Each protocol layer of the wireless terminal communicates with the corresponding protocol layer implemented in the network. The upper layers of the protocol stack are illustrated in FIG. 1. Topmost in the protocol stack there is an application layer 110, which comprises applications for implementing different services for users. In FIG. 1, these applications are called service applications. SIP protocol is located below the service applications in the application layer and forms a kind of application layer sublayer, which may be called a session management layer 115.

Below application level, there is typically a transport layer 120, and below that other layers not presented in FIG. 1.

SIP protocol is an application-layer control and signalling protocol, by means of which the user may log with his/her wireless terminal on application-layer services in a network and log out of them. If a service, which the user has logged on with his/her wireless terminal, is in unused mode and the user has not logged out of the service, the SIP protocol logs the user out of the service when the unused mode has lasted for a predetermined time. Time is monitored with a timer in the network. When the timer's time expires, the user is logged out. In this way, one strives for optimising network resource management so that the user's files, which are reserved and maintained related to each service, are not unnecessarily reserved and maintained, when it seems that they are not needed anymore.

If the wireless terminal switches off or is switched off by the user, the network acts in a similar way, that is, when the network timer's time expires, the user is logged out of the service.

Now an invention has been made which aims to optimise the logging of a user out of an application-layer service. According to a first aspect of the invention, there is provided a method for logging a user out of an application-layer service, the service being implemented with the aid of the user's wireless terminal, the terminal implementing a protocol stack comprising an application layer, and which application layer comprises:
a set of service applications for implementing application-layer services; and an application-layer control and signalling protocol, such as SIP (Session Initiation Protocol), for logging the user on application-layer services in a network and for logging the user out of application-layer services. In the method:
when switching off the wireless terminal, the user is logged using the application-layer control and signalling protocol out of at least one application-layer service of which the user has not logged out, or a conditional request for logging out the user is sent to the network.

According to an advantageous embodiment of the invention, the expiring of the time in network timer is not waited, but immediately when switching off the wireless terminal, the user is automatically logged out of the unclosed services in the network, whereupon network resources are saved compared to a prior-art solution, in which the user's files are reserved and maintained also after the switch-off of the wireless terminal until the time in the network timer is expired. An additional advantage of the invention is that, for example concerning a Presence service, other Presence service users see immediately that the user has logged out of the service (or is offline) and thus do not try to send messages to the outlogged user which would waste network resources.

The wirelessness of the terminal refers to that the terminal is able to communicate wirelessly with the network. The automatic nature of the log out, on the other hand, refers to that the terminal takes care of logging out “automatically” without the user, that is, without the user manually accessing the service with his/her terminal to log out of the service.

Preferably, the application-layer control and signalling protocol is SIP (Session Initiation Protocol). Alternatively, it may be another application-layer control and signalling protocol, which applies to the same purpose than SIP and in which a similar problem occurs.

Preferably, the log out of the application-level service is performed in addition to a transport-layer level log-out (for example, GPRS, General Packet Radio Service).

According to a second aspect of the invention, there is provided a wireless terminal according to claim 15.

According to a third aspect of the invention, there is provided a network element according to claim 17.

The invention is explained in more detail in the following by way of examples by referring to the enclosed drawings, in which

FIG. 1 presents the upper layers of layer-structured protocol stack,

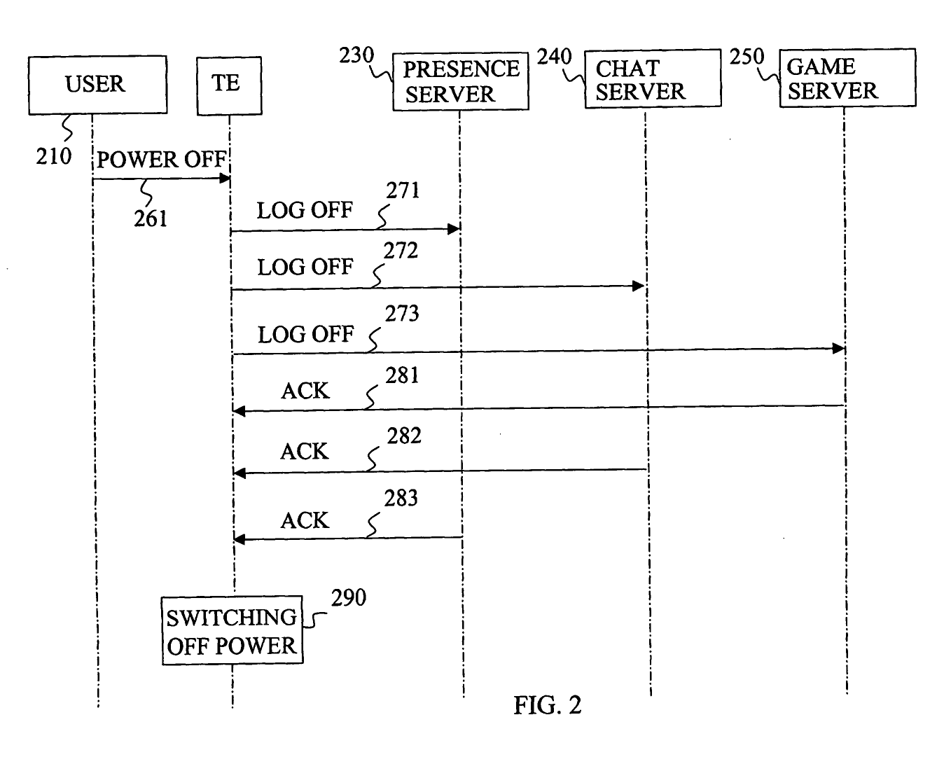

FIG. 2 presents a method according to a first embodiment of the invention,

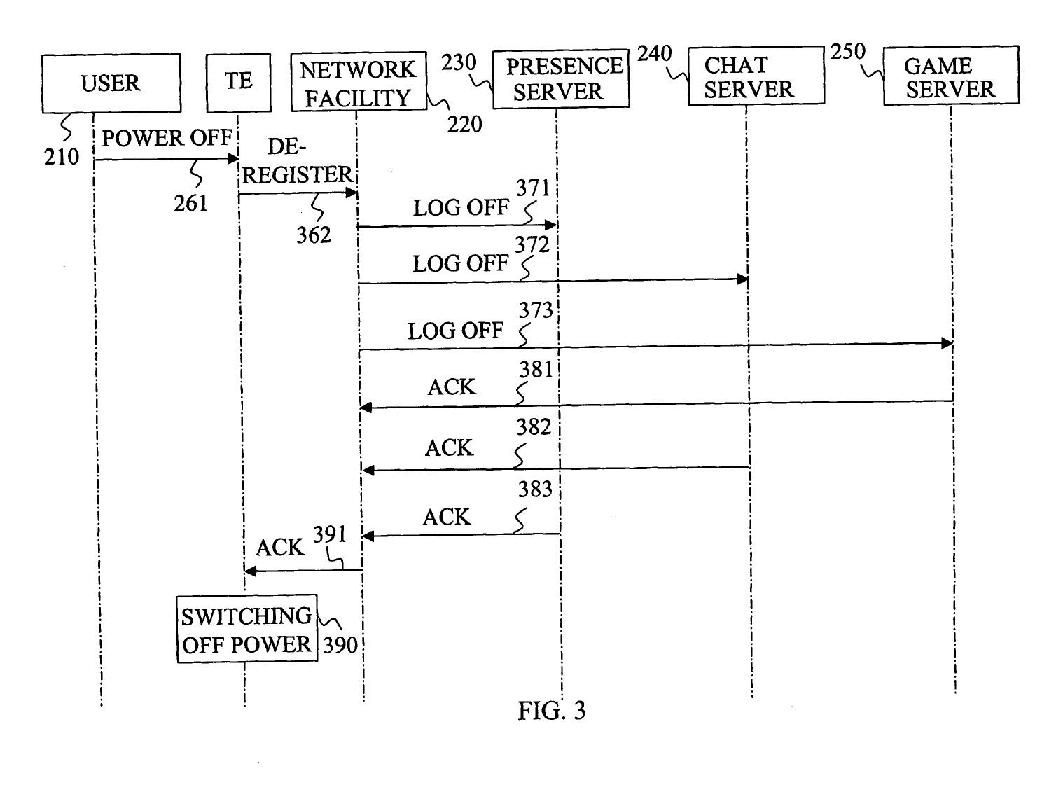

FIG. 3 presents a method according to a second embodiment of the invention,

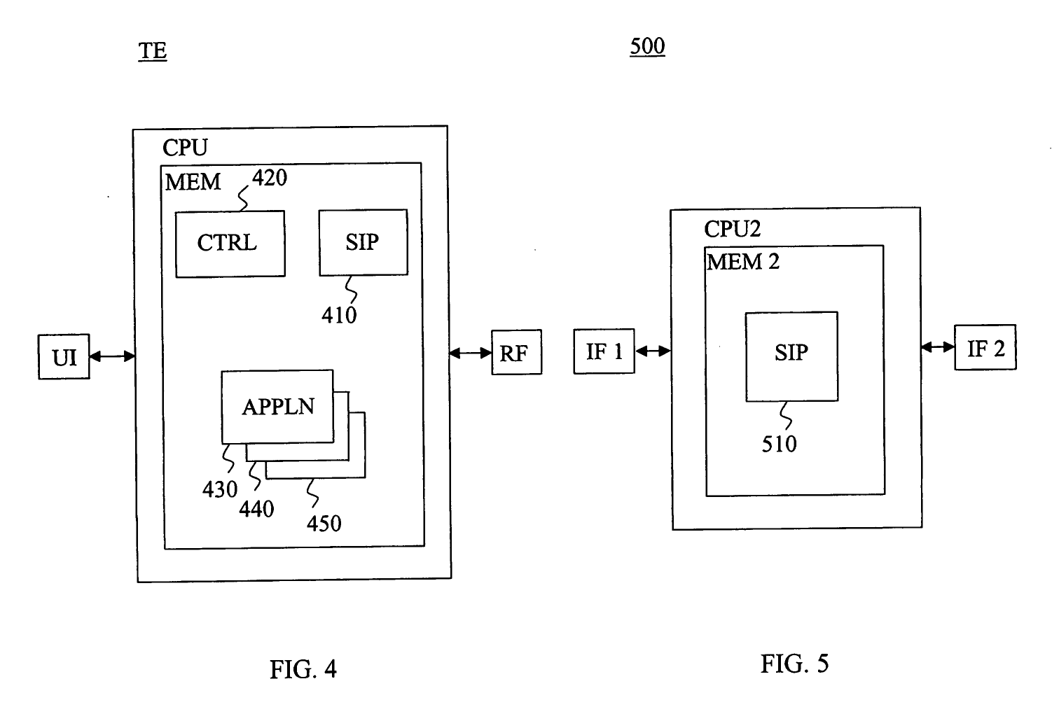

FIG. 4 presents a terminal applicable for implementing the invention,

FIG. 5 presents a network element applicable for implementing the invention.

FIG. 1 was explained above in the context of the description of prior art. FIG. 2 presents a method according to a first embodiment of the invention, in which the user is automatically logged out of an application-layer service or services when switching off the wireless terminal. The log out of the user applies to those application-layer services, which are on the network side in active mode or unclosed when the switching off of the wireless terminal is initiated. In other words, logging out applies to those application-layer services, which the user has logged on with his/her wireless terminal, but of which the user has not, for some reason, manually logged out by the time that the switch-off of the wireless terminal is initiated.

In the example of FIG. 2, those application-layer services, which the user 210 has logged on (or registered) with his/her wireless terminal TE, but of which the user has not manually logged out (or registered out), are the following: a Presence service (the user has logged on the service with the aid of a Presence server 230), a Chat service (the user has logged on the service with the aid of a Chat server 240) and a game service (the user has logged on the service via a game server 250). In practice, logging on a service may mean opening a session with a server, and logging out may mean closing the session opened for the user.

When the user 210 of the wireless terminal TE now gives a switch-off command 261 for the terminal, for example by pushing the on/off button of the wireless terminal TE, the actions will be the following according to the first embodiment of the invention. First, the wireless terminal TE verifies from its memory those application-layer services, which the user 210 has logged on with his/her terminal TE, but of which the user has not logged out. Then, the wireless terminal TE forms a log-out message 271 (LOG OFF) and sends it to the servers in the network which produce each application-layer service. LOG OFF is only sent to those servers with the aid of which each service has originally been logged on. In the example of FIG. 2, LOG OFF is sent to the Presence server 230 (message 271), to the Chat server 240 (message 272) and to the game server 250 (message 273). After receiving the LOG OFF message each server logs the user 210 out of the service with a method known as such. Each server responds to the LOG OFF message with an acknowledgement message ACK (messages 281-283). When the wireless terminal TE receives the acknowledgement messages ACK, it closes by switching its power off (block 290).

In an alternative implementation of the first embodiment of the invention, the wireless terminal TE switches the power off after a determined time after sending the LOG OFF messages 271-273, even though all ACK messages 281-283 would not have arrived at the wireless terminal TE. Another alternative is that the wireless terminal TE switches the power off immediately after sending the LOG OFF messages without waiting for any acknowledgements.

As the wireless terminal TE in the first embodiment of the invention automatically (without active measures of the user) logs the user 210 out of application-layer services in the network, the network simultaneously stops reserving and maintaining the user's files related to each application-layer service. Thus, network resources may be saved compared to a prior-art solution, in which the user's files are reserved and maintained also after the switch-off of the wireless terminal until the time in the network timer expires.

FIG. 3 presents a method according to a second embodiment of the invention. The second embodiment provides a centralised log-out solution, in which a particular facility in the network handles log-out in a centralised manner, thus differing from the first embodiment, in which the wireless terminal TE itself sends the LOG OFF messages to different servers 230-250.

In the example of FIG. 3, those application-layer services, which the user has logged on with his/her wireless terminal, but of which the user has not logged out, are the same as presented in the example of FIG. 2, that is: the Presence service, the Chat service and the game service.

When the user 210 of the wireless terminal TE gives the wireless terminal a switch-off command 261, the actions will be the following according to the second embodiment of the invention. The wireless terminal sends to a particular facility 220 in the network a log-out message DE-REGISTER (message 362). This message indicates to the network facility 220 that the wireless terminal TE of the user 210 is being switched off. The facility 220 now sends a log-out message (LOG OFF) to those servers, which produce services which the user 210 has logged on with his/her wireless terminal TE, but of which the user has not logged out. LOG OFF is only sent to those servers, with the aid of which each service has originally been logged on. In the example of FIG. 3, LOG OFF is sent to the Presence server 230 (message 371), to the Chat server 240 (message 372) and to the game server 250 (message 373). After receiving the LOG OFF message, each server logs the user 210 out of the service with a method known as such. Each server responds to the LOG OFF message with an acknowledgement message ACK (messages 381-383). When the facility 220 receives the acknowledgement messages ACK, it sends an acknowledgement message ACK (message 391) to the wireless terminal TE. When the wireless terminal TE receives the acknowledgement message ACK, it closes by switching its power off (block 390).

In an alternative implementation of the second embodiment of the invention, the wireless terminal TE switches the power off immediately after sending the DE-REGISTER message 362 without waiting for the acknowledgement message ACK (message 391), which speeds up the switch-off of the wireless terminal.

When implementing the second embodiment of the invention, it is to be noted that the facility 220 has to obtain from somewhere information on those application-layer services (and servers), which the user 210 has logged on with his/her wireless terminal TE, but of which the user has not logged out. This information may be provided for the facility 220 in three alternative ways:
1) The logging on services (and logging out of them) is forced to pass via the facility 220. According to this alternative, the wireless terminal TE sends all messages, with which the user 210 logs on application-layer services, first to the facility 220 which forwards the messages to different servers.
2) The wireless terminal TE sends the information to the facility in the DE-REGISTER message.
3) Information is provided for the facility 220 via the network. In this alternative, information on unclosed services may be maintained in a particular register (not shown) in the network, from which the information is delivered to the facility 220 when needed.

Alternatively, if the facility 220 does not receive information on services of which the user 210 has not logged out, it may check from the network user profile (not shown) those services, which the user 210 is permitted to log on, and send a LOG OFF message to all corresponding servers. Alternatively, the facility sends LOG OFF messages to all servers which, in its knowledge, provide the services in question.

A solution according to the second embodiment of the invention saves network resources compared to the prior-art solution for the same reason as the solution according to the first embodiment of the invention, but with the second embodiment of the invention, one also obtains an additional advantage compared to the first embodiment of the invention. Between the wireless terminal and the network (in which the facility and the other servers are located) there is typically an air interface, which is crossed by a radio link. The resources of the radio link are limited, and thus its unnecessary use should be avoided. With this respect, the second embodiment of the invention is better than the first one, because fewer messages have to be sent over the radio link in the solution according to the second embodiment.

The messages LOG OFF, DE-REGISTER and ACK are messages defined by an application-layer control and signalling protocol. Depending on the employed protocol, the names of the message may vary. In SIP (Session Initiation Protocol) protocol, either a BYE or a REGISTER corresponds to the LOG OFF message depending on with which message one has logged on the application-layer service. If the service was logged on with an INVITE message, the logging out is performed with the BYE message. On the other hand, if the service was logged on with a REGISTER message, also logging out is performed with a message with the same name (REGISTER). In fact, the REGISTER message in SIP also corresponds to the DE-REGISTER message known from the second embodiment of the invention. Message 2000K in SIP protocol corresponds to the ACK message. The network facility 220 may be implemented, when SIP protocol is involved, by software, for example, in a suitable network element, in which also other SIP protocol functions, such as CSCF (Call State Control Function), are implemented.

FIG. 4 illustrates a wireless terminal TE suitable for implementing the invention. The wireless terminal TE comprises a processing unit CPU, a radio frequency part RF and a user interface UI. The radio frequency part RF and the user interface UI are coupled with the processing unit CPU. The user interface UI typically includes a display and a keyboard (not shown), with the aid of which the user may use the wireless terminal TE. In addition, the wireless terminal TE may comprise a microphone and a loudspeaker (not shown).

The processing unit CPU comprises a processor (not shown), a memory MEM and software. The software has been stored in the memory MEM. With the aid of the software, the processor controls the operation of the wireless terminal TE, such as the use of the radio frequency part RF, displaying information on the display of the user interface UI and reading inputs arriving via the keyboard of the user interface UI.

The software comprises device management software 420, SIP software 410 and service applications, which are here: a Presence application 430, a Chat application 440 and a game application 450.

When the user 210 gives the wireless terminal TE a switch-off command 261 via the user interface UI, information on this arrives at the device management software 420.

According to the first embodiment of the invention, the device management software 420 informs the SIP software 410 of the switch-off command (information may pass via the service applications 430-450). The SIP software generates the log-out messages 271-273. The log-out messages are sent to the servers 230-250 via the radio frequency part RF. Also acknowledgements 281-283 are received via the radio frequency part RF, if the wireless terminal TE has not switched itself off before this. The wireless terminal TE is switched off by the device management software 420.

According to the second embodiment of the invention, the device management software 420 informs the SIP software 410 of the switch-off command (information may also pass via the service applications 430-450). The SIP software forms the log-out message 362 which is sent to the network facility 220 via the radio frequency part RF. Also, the acknowledgement message 391 is received via the radio frequency part RF, if the wireless terminal TE has not switched itself off before this. The wireless terminal TE is switched off by the device management software 420.

FIG. 5 illustrates a network element, which implements the facility 220 suitable for implementing the invention. The network element 500 comprises a processing unit CPU2, an interface IF1 to the direction of the wireless terminal TE and an interface IF2 to the direction of the servers 230-250. The interfaces IF1 and IF2 are coupled with the processing unit CPU2.

The processing unit CPU2 comprises a processor (not shown), a memory MEM and software. The software is stored in the memory MEM. The processor controls the operation of the network element 500 with the aid of the software.

Of the software, shown is only SIP software 510, which communicates with the terminal's SIP software 410 and the servers' 230-250 SIP software (not shown). The SIP software 510 implements the facility 220 and other SIP protocol functions in the network. It may, for example, implement a registrar known from the SIP protocol and/or a proxy server.

In the second embodiment of the invention, the SIP software 510 processes the log-out message 362 sent by the terminal TE and arriving via the interface IF1. The SIP software 510 forms the log-out messages 371-373, which are sent via the interface IF2 to the servers 230-250. The SIP software 510 also processes the acknowledgements 281-283 sent by the servers 230-250 and arriving via the interface IF2, and generates the acknowledgement 391, which is sent to the wireless terminal TE via the interface IF1.

It is to be noted that the wireless terminal TE may initiate a switch-off process either as a result of user actions (the user pushes the on/off button) or because the battery is empty. An alternative embodiment of the invention is especially suitable for the latter case. In this embodiment, the user 210 is not immediately logged out of the application-layer service in the network when switching off the wireless terminal TE. Upon receiving information on the initiation of the switch-off process of the terminal TE, the terminal software generates the DE-REGISTER message, which it sends to the network facility 220, but the message now comprises information on the fact that the facility 220 must wait a predetermined time, for example 3 minutes, before it sends the LOG OFF messages to the servers 230-250. Thus, the log out of the user of application-layer services can be delayed in a situation, in which the switch-off process of the terminal TE has initiated due to a battery becoming empty, in which case the user 210 may wish to continue with the service, after he/she has, after switching off the wireless terminal TE, replaced the battery or otherwise made the wireless terminal functional again.

If the user wishes to continue with the service, a new message which cancels the earlier sent DE-REGISTER message is sent, after restarting the wireless terminal, to the network facility 220 before the predetermined time expires. Then, the network facility does not send the LOG OFF messages to the servers 230-250, and the user may continue with the services he/she had logged on before switching off the wireless terminal TE.

If the new message is not sent before the predetermined time expires, the facility 220 sends the LOG OFF messages, as described in the context of the second embodiment of the invention.

When the battery is nearly empty, the user 210 may be enquired, via the user interface UI of the wireless terminal TE, whether he/she wishes to delay outlogging. This being the case, the user may also be enquired, after restarting, whether the user wishes the cancelling message to be sent.

In the just described alternative embodiment, the DE-REGISTER message may be considered a conditional log-out request. The log out is performed if the condition is fulfilled (that is, if the predetermined time expires), but log out is not performed if the condition is not fulfilled (that is, if, in this case, the new message is sent to the network facility before the predetermined time expires).

It is to be noted that the predetermined time (for example 3 minutes) is chosen so that, in that time, the user has time to replace the battery or otherwise make the wireless terminal functional again. The predetermined time is much shorter than the known prior-art network timer's time (for example presently in the SIP protocol 1 hour), in which case a major part of the resource saving advantages presented in context of the first and second embodiment are also achived in this embodiment.

In this specification, the implementation of the invention and its embodiments have been described by way of examples. It is clear to the person skilled in the art that the invention is not limited to the details of the foregoing embodiments, and that the invention may be implemented in another form without deviating from the characteristics of the invention. It is clear to the skilled person that, in addition to the messages described in the first and second embodiments, the wireless terminal may send before switching off also other messages to network in a manner known from prior art. For example, before sending a log-out message concerning the Presence service, it may be necessary to send a cancel message in order to first cancel a previous message sent in the service, if no acknowledgement has been received for it.

The described embodiments should be considered illustrative, but not limiting. The implementation and application possibilities of the invention are only limited by the accompanying patent claims. Thus, the different implementation alternatives defined by the claims, also equivalent implementations, pertain to the scope of the invention.

1. A method for logging a user out of an application-layer service, the service being implemented with the aid of the user's wireless terminal, the terminal implementing a protocol stack comprising an application layer, and which application layer comprises:
a set of service applications for implementing application-layer services; and
an application-layer control and signalling protocol, such as SIP (Session Initiation Protocol), for logging the user on application-layer services in a network and for logging the user out of application-layer services, characterised in that, in the method:
when switching off the wireless terminal, the user is logged out, using the application-layer control and signalling protocol, of at least one application-layer service of which the user has not logged out, or a conditional request for logging out the user is sent to the network.

2. The method according to claim 1, wherein the log out is performed automatically.

3. The method according to claim 1, wherein the user is logged out of at least one application-layer service of which the user has not yet logged out with the user terminal by the time the switch-off of the wireless terminal is initiated.

4. The method according to claim 1, wherein the protocol stack further comprises a transport layer, and wherein the log out of at least one application-layer service is performed in addition to a log out of the transport layer.

5. The method according to claim 1, wherein the log out is performed by sending a log-out message to such a server in the network, via which the user has logged on the service.

6. The method according to claim 5, wherein the wireless terminal initiates the log out by sending the log-out message to the server by itself.

7. The method according to claim 5, wherein the wireless terminal sends the log-out message to a facility in the network and the facility performs the log out in a centralised manner.

8. The method according to claim 7, wherein the facility is provided with information on the services which the user has logged on.

9. The method according to claim 8, wherein the information on the services is sent in the log-out message, which the wireless terminal sends to the facility in the network.

10. The method according to claim 5, wherein the log-out message is sent to all servers which the user has a permission to log on.

11. The method according to claim 1, in which a conditional request for logging out the user indicates a condition, such that if the condition is fulfilled, the user is logged out of the service.

12. The method according to claim 11, wherein the condition is fulfilled if the network has not been informed during a predetermined time that the log out must not be performed.

13. The method according to claim 1, wherein the at least one application-layer service is logged out by means of an SIP (Session Initiation Protocol) protocol.

14. The method according to claim 1, wherein the network is one of the following: 3GPP (3^{rd} Generation Partnership Project) Release 5 based network, All IP (Internet Protocol) network.

15. A wireless terminal comprising software for implementing a protocol stack, the protocol stack comprising an application layer, and which application layer comprises:
a set of service applications for implementing application-layer services; and
an application-layer control and signalling protocol, such as SIP (Session Initiation Protocol), for logging a user on application-layer services in a network and for logging the user out of application-layer services, characterised in that the terminal comprises:
software for logging the user, when switching off the wireless terminal, by using the application-layer control and signalling protocol, out of at least one application-layer service of which the user has not logged out.

16. The terminal according to claim 15, which comprises software for sending a conditional request to the network for logging out the user.

17. A network element comprising software for implementing an application layer of a protocol stack, and which application layer comprises:
an application-layer control and signalling protocol, such as SIP (Session Initiation Protocol), for logging a user out of application-layer services in a network, and which network element comprises:
software for logging the user, when switching off a wireless terminal, by using the application-layer control and signalling protocol, out of at least one application-layer service of which the user has not logged out.

18. The network element according to claim 17, which comprises software for receiving a conditional request from the wireless terminal for logging out the user.
